(19) United States
(12) Patent Application Publication
(10) Pub. No.: US 2007/0106624 A1
(43) Pub. Date: May 10, 2007

(54) System, method, and apparatus for assessing injury risk

(76) Inventors: Kevin James Taylor, Christchurch (NZ); Robert van Nobelen, Christchurch (NZ)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/592,764

(22) Filed: Nov. 3, 2006

Related U.S. Application Data
(60) Provisional application No. 60/734,010, filed on Nov. 4, 2005.

(51) Int. Cl. G06F 17/00

(52) U.S. Cl. 705/500

(57) ABSTRACT

The invention relates to a method of assessing injury risk, an injury risk assessment system, and computer-executable instructions configured to facilitate a method of injury risk assessment. The methodology of the invention employs the extraction of at least one user risk variable from a user assessment data set. Once user risk variables are extracted an exposure parameter can be calculated where this exposure parameter is based on at least one user risk variable, and also at least one correlating population risk variable.

### CROSS-REFERENCE TO RELATED APPLICATIONS

This application claims priority from U.S. Provisional Patent Application No. 60/734,010, filed on Nov. 4, 2005, which is incorporated herein by reference in its entirety.

### BACKGROUND OF THE INVENTION

1). Field of the Invention

This invention relates to a system, method, and apparatus to be used to assess injury risk. In particular applications, the present invention may be employed to assess the risk of injury present for users of computer input devices. The present invention may also be used to identify and/or categorise particular users of such input devices depending on their level of injury risk.

2). Discussion of Related Art

For some complaints it can be difficult to assess a person's risk of developing a certain injury where such complaints are caused over time by a number of risk factors working together. For example, stress-related conditions or repetitive strain injuries have been identified as complaints which are associated with a wide number and range of variable risk factors.

The monitoring, prevention, and treatment of work-related muscular-skeletal disorders is an important issue to many organisations and employers. For example, repetitive strain injury disorders affect the health, well-being and productivity of a work force who employ computer input devices, such as mice or keyboards, in the day-to-day performance of their duties.

The current state of the art in this field provides software-based tools to facilitate injury prevention and rehabilitation. A good example of this type of existing tool is provided by the present applicant and is currently detailed at the internet domain www.workpace.com. This Workpace software product monitors a computer user's input behaviour and can provide reminders with respect to the timing of breaks they should take and exercises to be completed to reduce their risk of injury. Warnings can also be provided to users if they exceed recommended typing speeds or work for too long without a break.

However, the current state of the art of this field does not necessarily allow for the proactive assessment and identification of computer users at significant risk of injury, nor can it subsequently recommend the most relevant risk factors appropriate for these users which should be addressed to reduce risk levels.

The first step involved with proactively addressing these issues is the recognition of computer users who are at risk of injury, or who may have a pre-existing condition aggravated by the use of computers. The assessment of injury risk in this field is difficult to complete accurately or quantifiably due to a significant number of variables at work which can contribute to such injuries.

Work station ergonomics, user fitness, posture and stress levels, typing speed and typing period durations, mouse speed and period durations, breaks or pauses taken by users, and exercises completed by users all have an impact on risk of injury. Those working in this field will also appreciate that a large number of significant variables have an effect on a computer user's risk of injury, and the above list of factors should in no way be considered comprehensive.

The determination or assessment of injury risk is also a comparatively new and evolving field. Rigorous scientific examination of contributing risk factors and underlying risk factors has yet to be completed to an exhaustive level for all relevant variables. Such research usually focuses on single risk factors and the importance or the weight that should be applied to their relevance in terms of overall risk to a computer user. At present the applicants note that there is insufficient scientific data available to enable the accurate calculation of risk weightings and relative risk ratios when different factors are considered across the entire range of potential risk factors involved.

Such available scientific data and conclusions also may not necessarily be relevant to specialised or niche behaviour computer users. For example, the largest number of computer users generally type long passages of text. Conversely, CAD operators work primarily through mouse movements, clicks and drag operations, whereas computer programmers employ a collection of disjointed specialised symbols in combination with a reasonable number of mouse operations, and frequent breaks to compile source code. Therefore scientific data and studies sourced from general text typists may not necessarily be applicable to other computer users with different behavioural modes.

Furthermore, such pre-existing studies and conclusions with respect to risk factors may be superseded by new technology which is employed in novel ways by users. In particular the use of laptop computers requires a reassessment of the importance or weighting of particular risk factors when the specific location in which laptops are used is to be considered. Furthermore, the compressed configuration of the laptop keyboard and trackball mouse add new variables to the mix of factors to be considered when injury risk is assessed.

It would therefore be of advantage to have a method, system, or apparatus available which could effectively assess a computer user's injury risk in spite of the above problems. In particular, an injury risk assessment scheme, system, or methodology which could compare one subject's behaviours and/or conditions with a group of that subject's peers, or a relevant population of computer users during the assessment of injury risk could also be of advantage. Furthermore, a risk assessment system, method, or apparatus which could rapidly categorise users and identify particular users for immediate or detailed investigation would also be of advantage. In addition, an injury risk assessment method, system, or apparatus which could extrapolate data from previously received input data based on information derived from a relevant population of computer users would also be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand, the United States, or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description, which is given by way of example only.

### SUMMARY OF THE INVENTION

According to one aspect of the present invention there is provided a method of assessing injury risk by determining at least one user's exposure to at least one risk factor, characterised by the steps of;
(i) receiving user assessment data which includes at least one user risk variable, said at least one user risk variable being associated with a risk factor for which at least one user's exposure is to be determined, and
(ii) calculating an exposure parameter for said at least one user based on said at least one user risk variable and at least one correlating population risk variable.

According to a further aspect of the present invention, there is provided an injury risk assessment system adapted to determine at least one user's exposure to at least one risk factor, said system including,

an input means adapted to receive at least one set of user assessment data and at least one population risk variable, and

a processor programmed to extract at least one user risk variable from a received set of user assessment data and to calculate at least one exposure parameter based on a correlated user risk variable and population risk variable.

According to yet another aspect of the present invention, there is provided an injury risk assessment system substantially as described above, wherein the input means is in communication with a dynamic data store, said dynamic data store being configured to store a plurality of individual sets of user assessment data sourced from a plurality of users, said dynamic data store being configured to dynamically update said stored individual user assessment data sets.

According to yet another aspect of the present invention, there is provided computer-executable instructions stored on a computer-readable medium, said computer-executable instructions being adapted to execute the steps of;
(i) extracting at least one user risk variable from a user assessment data set, and
(ii) calculating an exposure parameter based on at least one user risk variable and at least one correlating population risk variable.

The present invention is adapted to provide a system, method, and apparatus for assessing injury risk. The injuries for which risk is to be assessed may vary widely depending on the application in which the present invention is to be employed.

In general, reference will be made throughout this specification to the present invention being employed to assess the risk of repetitive strain injuries (RSI) occurring through the use of computer systems. RSI is a complaint which occurs frequently when a wide number and range of risk factors are present for a sufferer, with all of these risk factors contributing to the resulting injury.

However, in other embodiments different types of injuries, ailments, or complaints may be considered in conjunction with the present invention. For example, in an alternative embodiment the present invention may be used to assess risks associated with stress-related disorders or complaints. Again, these types of injuries are generally caused by a wide number and range of risk factors being present in combination and at different degrees.

Reference throughout this specification will, however, be made to the present invention being used to assess a user's risk of developing an RSI-related complaint. However, as discussed above, those skilled in the art should also appreciate that other types of injuries and a user's risk of developing same may be assessed in conjunction with the present invention, if required.

The present invention may be employed to assess users, potentially with a view to identifying users with a high risk of developing an injury. Such an assessment may identify such users for immediate treatment or consideration before their injury involved has actually developed or become acute. Furthermore, the present invention may also be used in other instances to assess a group of user's risk of injury on the whole as a conglomerate, as opposed to assessing just a single individual user.

The present invention relates to a system, method, and/or apparatus configured to assess injury risk. In general terms, the present invention will be discussed throughout this specification as being implemented by a computer software-based tool configured to execute the methodology discussed below. Those skilled in the art should appreciate that the present invention therefore encompasses this methodology, computer-executable instructions adapted to facilitate the method involved, as well as computer hardware or equipment programmed with such instructions. A system or apparatus as discussed throughout this specification may encompass the use of a processor, where this processor is programmed with appropriate computer-executable instructions.

Reference throughout this specification will also be made to a user of the present invention being a person who operates a computer system and is at risk of developing RSI. However, those skilled in the art should also appreciate that employers or others with a vested interest in ensuring the health, safety, and productivity of computer users may all employ the present invention. Furthermore, information reporting functionality associated with the invention may also be employed by computer users, supervisors, or managers to assess the performance of a business or organisation on the whole with respect to reducing injury risk.

The present invention may preferably assess at least one user's exposure to a plurality of risk factors when making an injury risk assessment. In general terms, the larger the number of risk factors considered, the more accurate the risk assessment made can become. Those skilled in the art should appreciate that the risk factors considered will vary depending on the injury type involved and the data available from users from which an assessment may be made. These risk factors may be identified through research available in the field but need not necessarily be fully understood with respect to the impact they have on risk when compared with other factors.

In a further preferred embodiment, risk factors to be considered may include;
Level of computer use and breaks; Average and peak levels of computer use, number and length of breaks, level of mouse use, number of keystrokes.
Intensity of computer use; Typing speed, work/rest ratio, precision of mouse movements, mouse clicks/movements, monotonous or repetitive work.
Existing injury symptoms; Level of existing symptoms, location and duration of symptoms, current injury or history of past injury.
Usage ergonomics; Posture, positions of neck, forearms, hands and upper body, layout of desk, chair, screen, mouse and keyboard, copyholder.
Working environment; Quality of relationships with management and co-workers, support levels, company culture, job satisfaction, perceived workload, variability in workload, stress levels, ability to take breaks, control over type and amount of work, flexibility of work.
User characteristics; Physical fitness, muscle strength, gender, personality type, reaction to stress, coping abilities.

Preferably the present invention is adapted to receive and consider a user assessment data set to make an assessment with respect to a user's injury risk. This assessment data set may preferably be drawn from a variety of sources to give data as to the risk factors which a user is exposed to.

In a further preferred embodiment, such user assessment data may include computer usage information which is recorded or captured during the user's normal operation of a computer system. Such usage information may include typing and mouse movement and/or mouse button click event information. This information may also include timing information with respect to periods over which computer use occurred, as well as any breaks or pauses completed by the user during operation of a computer system.

In a preferred embodiment, a user assessment data set may also include information drawn directly from a user through a feedback questionnaire or through an interview or meeting completed with the user. The user's responses to such questions can span a variety of fields and relate to areas which may not necessarily be measured or investigated through simple computer usage information.

For example, in a further preferred embodiment where the risk factors discussed above are considered, a user feedback questionnaire may be tailored to request responses from a user on all identified risk factors, irrespective of whether these risk factors are encompassed by available computer usage information. Users may report on their own perception of computer usage levels as well as, for example, their own perception of their posture and workstation ergonomics, and the existing physical complaints they may have as well as the speed and intensity of work, work load and work environment, and the individual factors of risk discussed above. In effect, each of the risk factors identified for consideration may act as a reference for a particular user risk variable, where the information collected in relation to each risk factor can vary from user to user.

However, in some alternative embodiments the user assessment data set considered may not necessarily incorporate such direct user feedback information. For example, in some instances where an immediate or fast assessment of a large number of users is to be completed, a simple injury risk assessment may be made using computer usage information or data only. This computer usage information is readily available and may be rapidly assessed to provide the injury risk assessment required. Conversely, the completion of feedback questionnaires by users or potentially interviews with users is a relatively time-consuming process, which may be reserved for users which have already been identified as potentially at high risk of injury.

In some embodiments, a user assessment data set may also incorporate data not sourced directly from the user for which an injury risk is to be assessed. For example, in some instances, it may not be possible to collect all requested data or information that is employed to compose the full or entire user assessment data set. In some cases, users may be confused by questions presented to them or may refuse to supply the information requested due to cultural or religious grounds. When this occurs, data sourced from a relevant population of other computer users or peers of the computer user may be employed to fill in or supply missing information. Preferably, such population-based data may be selected from the average or standard response usually given, so as not to inadvertently bias or contaminate the user assessment data set to be considered.

In some alternative embodiments a user assessment data set may be composed from a conglomerate of a number of individual user assessment data sets associated with a number of individual users. This conglomerate of user assessment data sets may in effect provide a user assessment data set which spans a particular group of users, such as those present within an organisation or department. In such instances such a conglomerate-based user assessment data set may be considered in conjunction with the present invention.

However, in the main reference throughout this specification will be made to a user assessment data set incorporating data sourced from or associated with a single user only. However, those skilled in the art should appreciate that a user assessment data set as described throughout this specification may be composed from data sourced from a plurality of users within an identified group if required. Therefore the present invention may be used to assess one or a plurality of users when making an injury risk assessment.

Preferably, a user assessment data set may be composed of or incorporate a plurality of user risk variables. These variables may change from user to user and be indicative of each user's exposure to a particular risk factor. Furthermore, in some instances, a single risk variable may be representative of a user's exposure to more than one risk factor or alternatively represent exposure to a single risk factor. In general terms a user risk variable may effectively provide a quantifiable measure of a user's exposure to a risk factor.

For example, in a preferred embodiment, where the risk factors of typing speed and typing period durations are to be considered, associated user risk variables may be provided directly through measuring a user's typing speed and typing period duration. Those skilled in the art should appreciate that the form of user risk variables considered will be directly dictated by both the risk factors to be considered as well as the types of user assessment data available.

However, in other embodiments a user risk variable may not be representative of a single risk factor in isolation. For example, in some other embodiments a user risk variable or a risk variable in general may be composed from a conglomerate of individual risk factors with associated individual variables which may be combined, aggregated, or averaged to provide a risk variable which spans a number of risk factors.

Those skilled in the art should appreciate that a single risk variable may span both a single measurement of a particular variable, through to a conglomerate or combination of a number of variables which may be associated with a range of risk factors. However, in general throughout this specification reference will be made to a risk variable being associated with a single measured parameter.

The present invention may calculate an exposure parameter for a user in relation to the user's exposure to a particular risk factor or a number of related or similar risk factors. This exposure parameter may be calculated through a direct comparison between a user risk variable and its correlating population risk variable.

Preferably, a population risk variable may be associated with a risk factor and may be drawn from a collection of user assessment data sets from a population of users. Such population risk variables may be composed from the same data or information types providing a user risk variable. Population risk variables may therefore give indications as to the relative exposure of a user to a particular risk factor when compared with a relevant population of other computer users also potentially exposed to the same risk factor.

Population risk variables allow for a relative comparison of risk against a relevant population of users, and potentially allow risk to be determined quantifiably without the need for exhaustive research pertaining to the specific relevance of a particular risk factor. If, for example, a user is shown to have an elevated level of exposure to a risk factor when compared with a relevant population of users, this in turn can indicate the user has an elevated level of risk—as should be reflected by the exposure parameter calculated.

Preferably, the population risk variable or variables used may be drawn from a relevant population of users, preferably being the peers of the user currently being assessed. For example, if the user being assessed is a CAD operator or a heavy user of a laptop computer system, the population assessment data employed to provide population risk variables may be drawn again from CAD operators or laptop users. Conversely, in other embodiments if required, a baseline comparison against a global population of all computer users (irrespective of behaviour) may be employed to provide the population risk variables required.

In a preferred embodiment, an exposure parameter may be calculated using a compilation or composite numeric value associated with a correlating population risk variable.

For example, in one embodiment an average numeric value for a population risk variable may be calculated for subsequent comparison to the actual value obtained from the user under assessment. In such instances, a population risk variable can be calculated from an average of the plurality of correlating risk variables sourced from the population selected for the user to be assessed.

Alternatively, median values may be calculated for the associated population risk variable, or data distributions may be considered for the population risk variable where the user risk variable is compared against a particular threshold percentile of the distribution. In such embodiments, a population risk variable can be selected from the user assessment data of at least one population member at a particular distribution point of the population. For example, the 85^{th} percentile of a population distribution may be selected and the correlating risk variable present within the data set of population members at this 85^{th} percentile point may be used as the population risk variable.

Those skilled in the art should appreciate that a wide number and range of operations may be completed to provide a compiled numeric indication of an entire population's exposure to a particular risk factor depending on the form of the exposure parameter to be calculated.

In a preferred embodiment, an exposure parameter may consist of a binary indication as to whether or not a risk factor is present for a particular user. For example, a threshold level or degree of exposure may be defined to positively identify the presence or action of a risk factor for a user. In such instances, if a user's risk variable is thirty percent greater than the average for the population risk variable, or alternatively if the user is in the 90th percentile of users when the distribution of the population risk variable is considered, then a risk factor can said to be present for the user.

However, in alternative embodiments an exposure parameter may not necessarily be formed by a binary indication as to the presence or absence of a risk factor for a user. For example, in other embodiments, an exposure parameter may be formed from a ratio of a composite population risk variable to that of the corresponding user risk variable. Alternatively, a percentage indicator may be provided as an exposure parameter. In yet other embodiments, an exposure parameter may be formed by a magnitude-based numeric value to be compared against a fixed numeric scale. Those skilled in the art should appreciate that various forms or configurations of exposure parameters may be employed in conjunction with the present invention and discussion throughout this specification of a binary or scale-based numeric exposure parameter should in no way be seen as limiting.

The present invention may facilitate the calculation of a plurality of exposure parameters with a view to completing an injury risk assessment for a user. Each exposure parameter calculated may be representative of a user's exposure to one particular risk factor in a preferred embodiment. Those skilled in the art should appreciate that the relevance, weight, or importance associated with each risk factor may be considered based on existing research to in turn apply general classifications to the user involved. For example, in a further preferred embodiment where binary format exposure parameters are employed, if a user is shown to have eighty percent or more of the risk factors considered this user may be considered to be at high risk of injury. Again however, those skilled in the art should appreciate that such exposure parameters once calculated may be used in a number of different ways to assess a user's injury risk.

As discussed above the present invention also encompasses a system or collection of computer hardware adapted to facilitate the method of assessment provided. Preferably, such a system may incorporate a processor which can be loaded with computer-executable instructions. This processor may form part of a computer system which is actually employed by a user and can concurrently capture computer usage information while also providing the risk assessment facility required. Such a system may also present the user involved with a feedback questionnaire required to capture at least a portion of the user assessment data employed. Furthermore, the processor provided may also complete the calculation of at least one exposure parameter based on user risk variables as extracted from an available user assessment data set.

Preferably, such an assessment system may also include an input means configured to provide data or information to the processor discussed above. Such an input means may be formed from, for example, a connection to a computer network in some instances, or alternatively may be formed by hardware employed to read data from computer-readable media such as compact discs, DVDs, tapes, flash drives, hard drives or any other known computer data storage media.

In a preferred embodiment, such an input means may be configured to receive at least one user assessment data set. This data set may be compiled directly by the processor and saved to a hard drive or other type of computer-readable media. Alternatively, such user assessment data may be transmitted to an input means via a computer network.

An input means may also be configured to receive at least one population risk variable or alternatively composite indications of population risk variables drawn from across an entire population of users. As discussed above, such composite indications may be formed from averages, median values, or data distributions associated with a population risk variable. The input means may be used to receive such population related indications to in turn facilitate the calculation of at least one exposure parameter.

In a preferred embodiment, an input means of an assessment system may be in communication with a dynamic data store. Such a data store may be configured to store a plurality of assessment data sets drawn from at least one population of computer users. The dynamic data store involved may in some instances classify users submitting assessment data sets depending on their modes of behaviour, organisation types for which the user works, or any other relevant criteria to resolve individual and distinct populations of users.

In a preferred embodiment, correlating population risk variables may be drawn from a dynamic data store which stores a plurality of sets of user assessment data sourced from a plurality of users. Such a data store may therefore be employed to either provide directly or assist in the formulation of an appropriate population risk variable when an exposure parameter is to be calculated.

In a further preferred embodiment, such a dynamic data store may also be configured to dynamically update stored individual user assessment data sets when more recent or current data sets are available in relation to a particular user. In such instances the data store may either replace the old data set or alternatively retain both new and old data sets for historical comparison.

In a further preferred embodiment, a dynamic data store may be provided through a database connected to or associated with a computer network. This dynamic database may be updated constantly with user assessment data from new users, or alternatively may update old user assessment data once the user involved generates new user assessment data. This database may also store old and new user assessment data to track the progress of a user or organisation.

In a further preferred embodiment, a system configured to implement the present invention may retrieve a plurality of user assessment data sets or alternatively compilations of same to facilitate the presentation of a summary report. Such reports may be implemented at the user level to provide information with regard to the risk factors present for a single user, or alternatively be provided at an organisation level to provide an indication of the risk factors present for all participating members of an organisation. Such reporting functionality may allow the current state of an organisation with respect to risk injury to be assessed at any one point in time.

Furthermore, the present invention may also be adapted to provide comparative population-based information to allow for benchmarking of organisations. In such instances an organisation may compare their own collected sets of user assessment data to those of a relevant population of computer users. This approach will then allow an organisation to analyse the effectiveness of any injury risk reduction programs in place, or alternatively allow the organisation to determine whether such programs should be launched.

The present invention may provide many potential advantages over the prior art.

The present invention can allow a quantifiable risk assessment to be made by the calculation of at least one exposure parameter through a comparison to a population of a user's peers. These comparative population assessments allow risk levels to be determined without the benefit of explicit scientific research which can assess user data in isolation. In effect, a statistical analysis approach may be taken to isolate or identify the most at-risk members of a population and to subsequently target the risk factors these high-risk users are exposed to.

The present invention can also take into account the unique behaviours of niche groups of computer users. A user may be compared with their peers to determine their relative risk when compared to others performing the same actions, exhibiting the same behaviour, or using the same computer hardware. Furthermore, due to the dynamic nature of the population-based data employed, the present invention may also be responsive to changing user hardware or behavioural trends.

The present invention may also be used as an analytical tool both to benchmark organisations against one another or a general population of users. Such reporting functionality may also be employed to provide a user with a snapshot view of where they stand within an organisation with respect to their own levels of injury risk.

The present invention may also provide a rapid user assessment tool when user feedback questionnaires are not employed to contribute to the user assessment data set. In such instances, computer usage information may be compared directly with appropriate population-based data to see where the user stands within a population and whether the user is likely to be categorised as being at high risk. Such fast identification of potential high risk users allows a large number of users to be assessed rapidly and for resources to be targeted to those at risk as soon as possible.

### BRIEF DESCRIPTION OF DRAWINGS

Further aspects of the present invention will become apparent from the ensuing description, which is given by way of example only and with reference to the accompanying drawings in which:

FIG. 1 shows a block schematic flowchart of information received and calculations made by an injury risk assessment system provided in accordance with one embodiment;

FIG. 2 illustrates a block schematic diagram of components employed to provide the injury risk assessment system discussed with respect to FIG. 1;

FIG. 3 illustrates instances of computer use data employed to form part of a user assessment data set in accordance with the embodiment of FIG. 1;

FIGS. 4a and 4b show portions of a user feedback questionnaire provided to capture direct user feedback information in accordance with the embodiment of FIG. 1;

FIG. 5 shows a block schematic diagram of hardware components employed to provide an injury risk assessment system in accordance with a further embodiment of the present invention;

FIG. 6 illustrates a flowchart showing the execution of a set of computer-executable instructions by the server machine illustrated with respect to FIG. 5; and

FIGS. 6a-6h provide more detail with respect to each of the sub-processes shown with respect to FIG. 6.

### BEST MODES FOR CARRYING OUT THE INVENTION

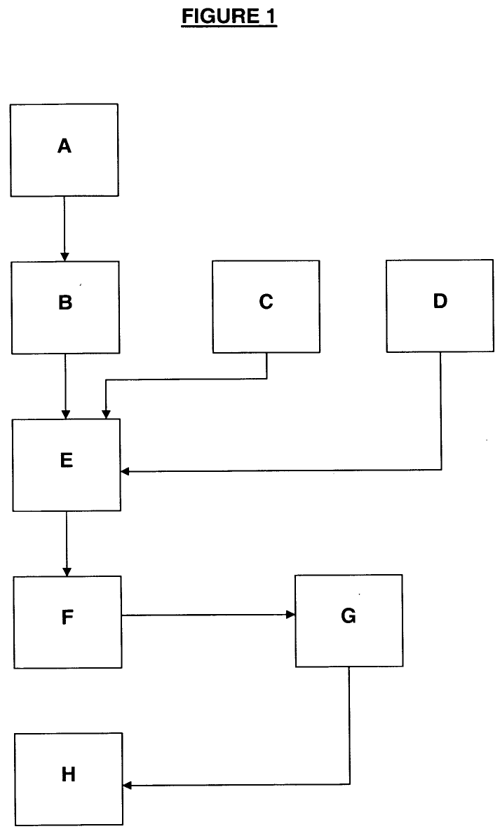

FIG. 1 shows a block schematic flowchart of information received and calculations made by an injury risk assessment system provided in accordance with a preferred embodiment of the present invention.

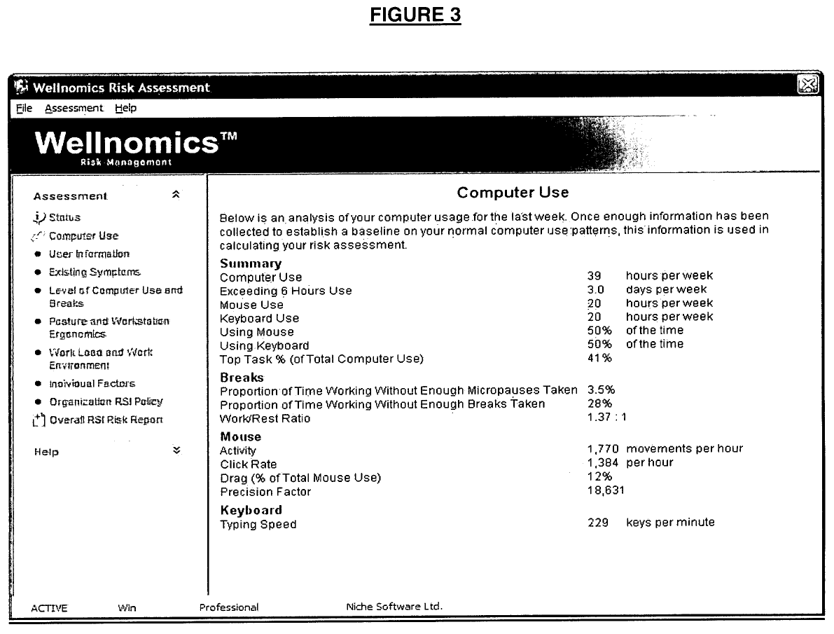

The first stage of the process executed by the system provided is shown at step A, where computer usage information is collected, received, or collated by the system. The forms and types of information collected at this stage are illustrated in detail with respect to FIG. 3, which shows a summary screen of general usage information. As can be appreciated by those skilled in the art, computer software tools such as the existing Workpace software product may readily be employed to collate and provide such computer usage information.

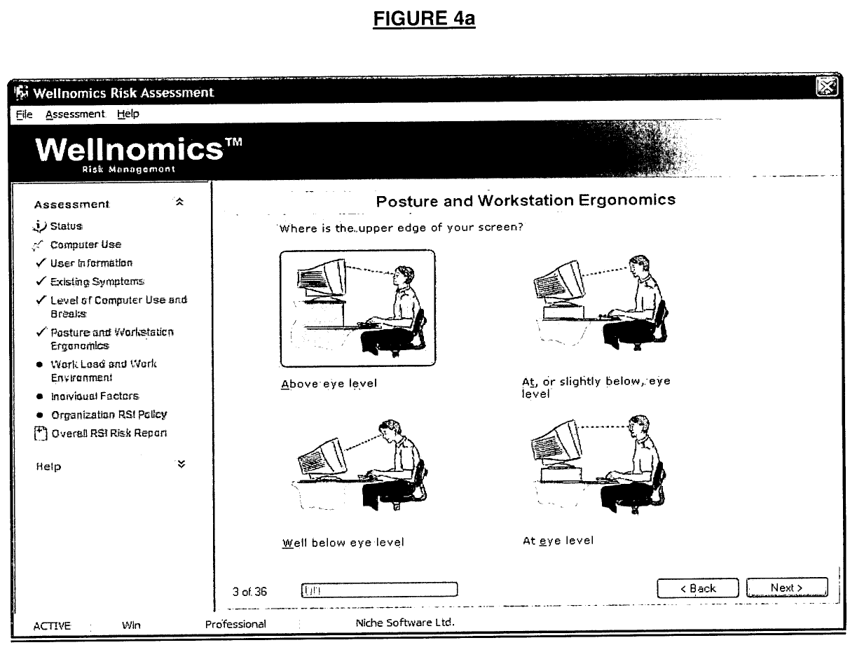

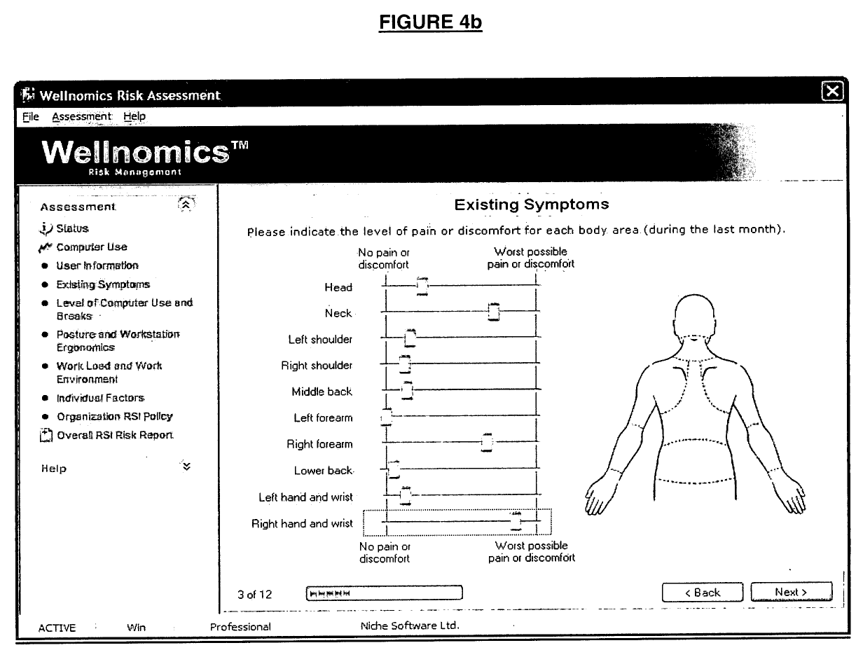

At step B of this process the assessment system collates or collects direct user feedback information. FIGS. 4a and 4b show screen shots of a questionnaire which can be presented to a user of the system to prompt and request they supply relevant information with respect to a number of injury risk factors which are not directly dictated or supplied by computer usage information.

For example, FIG. 4a illustrates a question which may be posed with respect to posture and workstation ergonomic risk factors, whereas FIG. 4b prompts a user to supply information with respect to any pre-existing complaints or injury symptoms they may have.

The computer usage and user feedback data collected at stages A and B is employed by the system to form a user assessment data set which incorporates a number of user risk variables. As can be seen from FIGS. 3, 4a, and 4b, these variables can range across diverse areas and can include quantitative data with respect to potential risk factors to which a user may be exposed. This data can form the user risk variables to be considered by the assessment system provided.

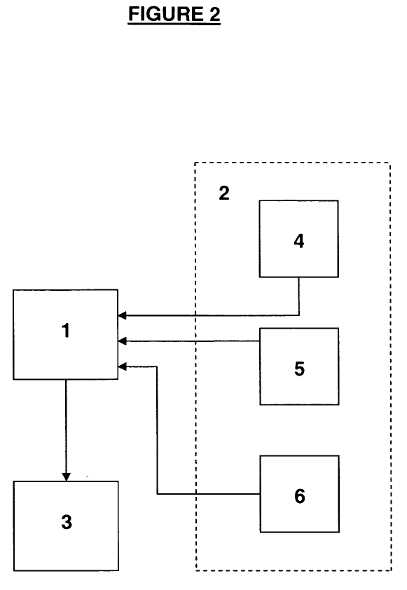

At stages C and D of the methodology executed, the system receives a number of different types of population risk variables. This population-based information may be received from a remote dynamically updated data store or database, as discussed in more detail with respect to FIG. 2.

In the case of stage C, distribution-based information and in particular threshold percentile levels for population risk variables may be received. Conversely at step D, average or median values for a population of computer users may alternatively be received. This population-based information correlates to the user risk variables collated at stages A and B, and gives a relative measure as to the state of the user currently being assessed when compared with a relevant population of other users.

At stage E of this process, the system provided can calculate a number of exposure parameters based on the user risk variables received and the correlating population risk variables received.

At this stage an exposure parameter may be calculated using population distribution information, depending on whether the user's risk variable is above or below that of a specific percentile position of users within the distribution. If the user's variable is below the threshold percentile level, a binary format exposure parameter indicating a negative presence for the related exposure factor is provided. Conversely, if the user's risk variable is above this percentile level, a positive binary exposure parameter will be provided.

In the case of numeric-based population risk variable information (as supplied at stage E), a direct comparison may be made against a user risk variable and an average of the population risk variables available. Again, a binary format exposure parameter may be provided in some instances, or alternatively the user risk factor may be divided by the population average to provide a ratio-based exposure parameter.

Those skilled in the art should appreciate that at stage E of this methodology, a number of exposure parameters can be calculated for all data available with respect to user risk variables and associated risk factors. This accumulated set of exposure parameters may therefore provide a direct measure as to the presence of a wide range and number of risk factors for a user. Furthermore, some of these exposure parameters may also span a range of values, giving an indication of the degree of exposure to a risk factor.

At stage F of this process, the exposure parameters are considered to in turn provide a general classification of risk for the user being assessed. If, for example, over sixty percent of all exposure parameters calculated indicate the presence of the risk factor involved, the user can be classified as being at medium risk of an injury developing. Conversely, if eighty percent of all exposure parameters indicate the presence of risk factors, the user can be classified as being at high risk of an injury developing.

At stage G of the methodology executed, the collated user assessment data at stages A and B, in combination with the exposure parameters calculated at stage E and the classification of the user provided at stage F, can be combined together and transmitted to a remote data store such as a database. This database can hold records of a large number of users' assessment data and associated exposure parameters and classifications, and in turn may be used as the source of population risk variables as employed with respect to stages C and D of this methodology.

At the final stage of this process (H), the system can request and retrieve summary or benchmark reporting data with respect to either a single user's risk factors or alternatively the risk factors of all assessed users within an organisation when compared with a larger relevant population of users. The database associated with the system can give a user, or alternatively an entire organisation, an overview as to the injury risk factors present within their environment and how they stand in comparison with their peers or other similar organisations.

FIG. 2 illustrates a block schematic diagram of components employed to provide the injury risk assessment system discussed with respect to FIG. 1.

The components of the system illustrated with respect to FIG. 1 include a microprocessor (1) and an input subsystem (2). The microprocessor (1) is also linked to an output system (3) such as a computer screen display or hard drive capable of recording output from the microprocessor (1).

The input subsystem (2) incorporates a storage means (4) configured to collate and store computer usage information pertaining to a particular user. As shown with respect to FIG. 3, this usage information may provide data with respect to how the input devices of the computer system associated with the microprocessor (1) are employed and for what length of time these input devices are employed.

The input subsystem (2) also includes a user feedback questionnaire collation system (5) which includes certain instructions to be executed by the microprocessor to present a questionnaire to a user to be assessed. Portions of such a questionnaire are illustrated by FIGS. 4a and 4b. This questionnaire system (5) can also record the responses of the user being assessed to provide user assessment feedback information to the microprocessor.

Lastly, the input system (2) includes a communications interface (6) which facilitates communications between the microprocessor (1) and a remote data store formed by a database. This database can supply to the microprocessor (via the input system (2)) population-based risk variable information to be employed in the methodology discussed with respect to FIG. 1.

The output system (3) can include both a computer monitor for information to be displayed to an observing user as well as a hard drive allowing the result calculations performed by the microprocessor (1) to be recorded. The output system (3) can also incorporate a communications interface, allowing the results of the microprocessor's calculations to be transmitted to a further remote computer system.

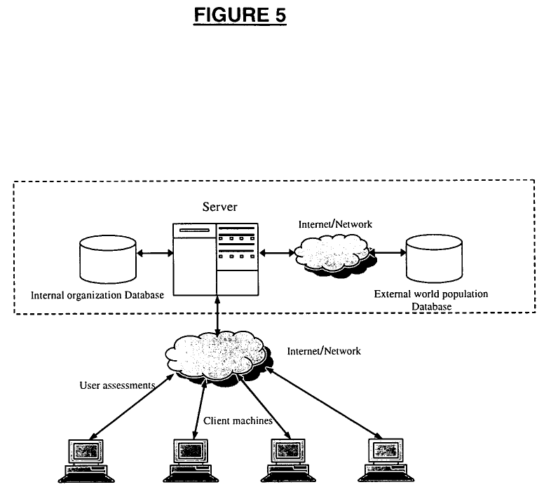

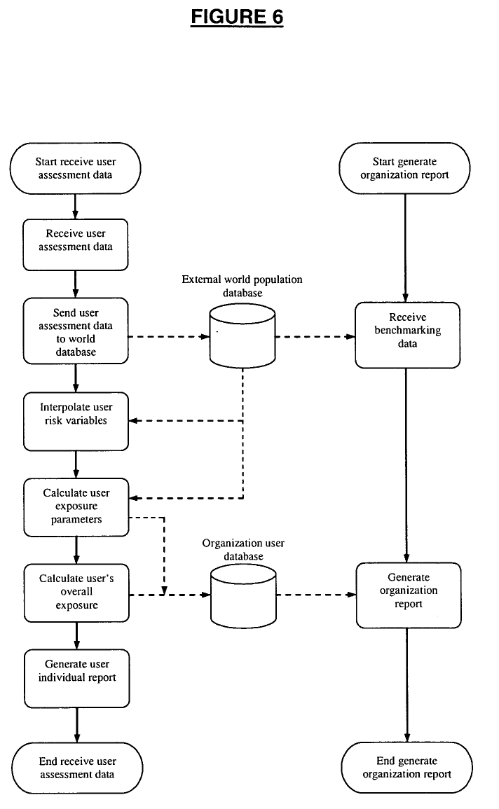

FIG. 5 shows a block schematic diagram of hardware components employed to provide an injury risk assessment system in accordance with a further embodiment of the present invention.

In particular, FIG. 5 illustrates a possible embodiment of the invention which includes;
1) A central shared server machine with a method for communicating with each of the client machines. For example, a modern PC running Windows Server, and an Ethernet network. This machine shall be referred to as the ‘server.’
2) A dynamic data store that is in communication with the server, containing user assessment data for the organization. For example, a database implemented using MS SQL server.
3) A dynamic data store that is in communication with the server, containing user assessment data for a large population of users, i.e., a plurality of organization assessments. This database would exist external to the organization, and be updated with datasets from other organizations independently.
4) A number of client machines that upload ‘user assessment’ data to the server. These machines facilitate the invention but are not part of the embodiment.

In this embodiment, the invention may be implemented by;
1) Machine-executable code that runs on the server machine that implements a method for processing any number of user assessment data sets.
2) An internal database containing the set of user-assessments and data of the organization.
3) An external database containing a plurality of user-assessment sets from a large cross-section of organizations. This shall be referred to as the ‘world population database.’

The server machine requires the following components, or equivalent functionality:
1) A CPU, or central processor for executing the machine instructions.
2) A local storage device for storing the machine-executable code and local copies of configuration files and user data (e.g. a hard drive or equivalent).

The user assessment data sent by the client machines to the server consists of three parts, namely
1) Computer usage data.
2) Computer configuration data.
3) User feedback data.

A more complex embodiment could include additional data sets.

The computer usage data relates to the manner in which the user uses the computer. In this embodiment, it simply consists of the number of hours per day the user used the computer. In a more complex embodiment, this could include many other statistics such as mouse use, number of keystrokes, typing speed, etc.

The computer configuration data relates to the type of computer and how it is configured. In this embodiment it simply consists of determining whether or not the computer is a laptop or desktop, and if it is a laptop whether or not it is set up in a desktop manner.

The user feedback data relates to other factors that influence computer usage health risks, and typically consists of a series of questionnaires covering topics such as posture and workstation, individual factors, work environment, workload and stress factors, etc. In this embodiment only three aspects of posture and workstation are asked of the user, namely:

Q1. Where is your computer screen positioned on your desk?

a) Straight in front.
b) To the side.
   Q2. Where is the upper edge of your screen?
a) At eye level.
b) Well above eye level.
c) Well below eye level.
   Q3. Do you tend to lean towards the screen?
a) No.
b) Yes.

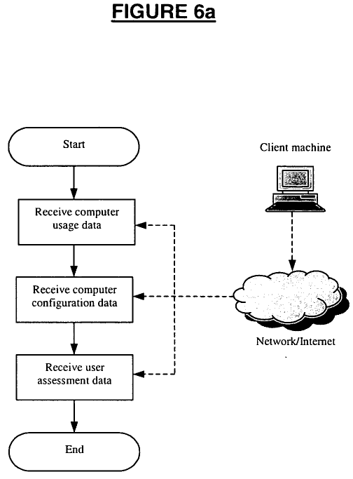

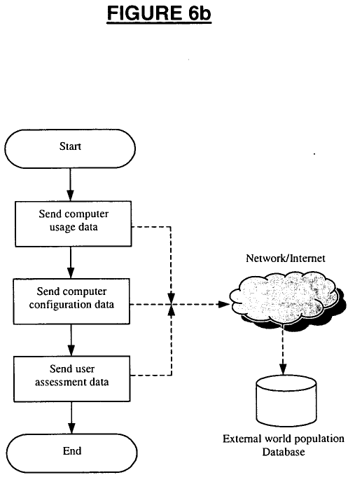

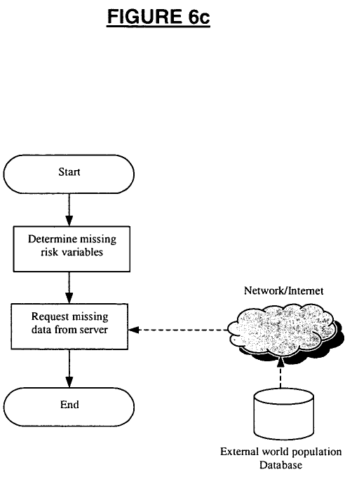

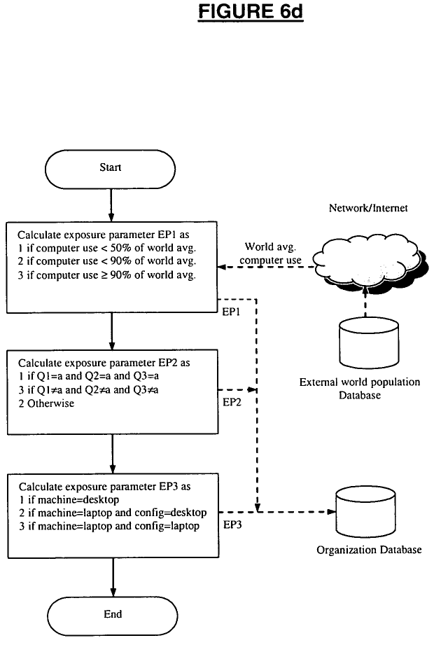

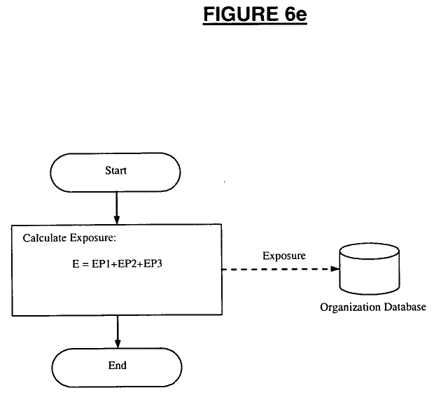

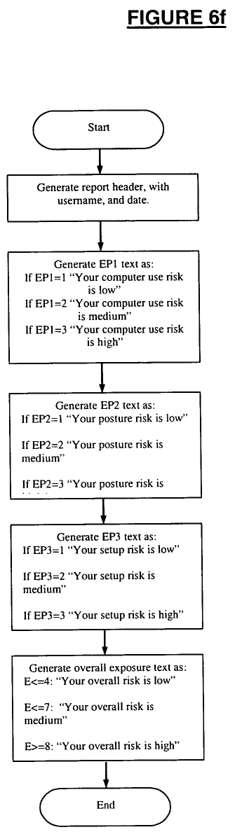

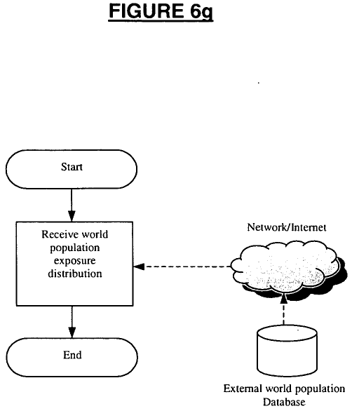

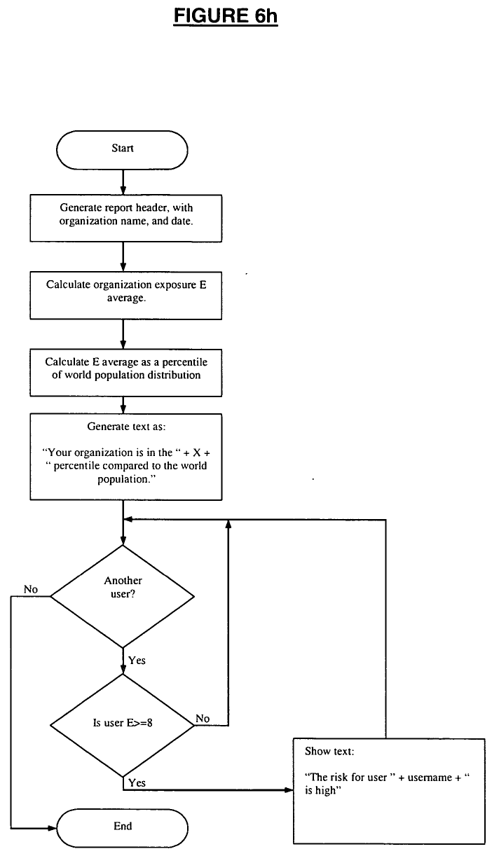

FIG. 6 illustrates the execution of a set of computer-executable instructions by the server machine shown with respect to FIG. 5. FIGS. 6a-6h provide more detail with respect to each of the sub-processes shown with respect to FIG. 6.

FIG. 6a provides further detail with respect to the ‘Receive user assessment data’ process shown with respect to FIG. 6. This process receives the user assessment data from the user client machine. This data consists of computer usage data, computer configuration data, and user assessment data.

FIG. 6b provides further detail with respect to the ‘Send user assessment to world data base’ process shown with respect to FIG. 6. This process sends the received user assessment data to the world database. This data consists of computer usage data, computer configuration data, and user assessment data.

FIG. 6c provides further detail with respect to the ‘Interpolate user risk variables’ process shown with respect to FIG. 6. The user assessment data set may be incomplete due to the user not knowing the answer to specific questions, or being unwilling to answer due to, for example, religious grounds. The unknown answers are approximated by using a population average from the world population database. In a more complex embodiment, the approximations could be based on the best-fit population profile based on job type, or other factors.

FIG. 6d provides further detail with respect to the ‘Calculate user exposure parameters’ process shown with respect to FIG. 6. This process calculates the user exposure parameters based on the user assessment data. Specifically one exposure parameter is calculated per category of data.
1) Exposure parameter EP1 is calculated based on computer usage data—note this is measured relative to the world population average.
2) Exposure parameter EP2 is calculated based on user feedback data.
3) Exposure parameter EP3 is calculated based on computer configuration data.

In a more complex embodiment, many more exposure parameters could be calculated.

FIG. 6e provides further detail with respect to the ‘Calculate user's overall exposure’ process shown with respect to FIG. 6. This process calculates the overall exposure for the user based on the exposure parameter calculations. As can be seen from FIG. 6e, such an exposure measure can be provided by summing the calculated exposure parameters.

FIG. 6f provides further detail with respect to the ‘Generate user individual report’ process shown with respect to FIG. 6. The process generates an individual user report. This report shows the risks present to the user. In a more complex embodiment, many more risk factors and exposure parameters could be reported upon, as well as advice on how to address the risks, comparisons to population averages, group averages, trends over time, and so forth.

FIG. 6g provides further detail with respect to the ‘Receive benchmarking data’ process shown with respect to FIG. 6. This process receives the benchmarking data from the world population server. This data is simply the overall exposure parameter distribution of the population for comparison to the organization. In a more complex embodiment, this could include many different types of benchmarks, such as distributions for job types, industry sectors, risk factors, and so forth.

FIG. 6h provides further detail with respect to the ‘generate organization report’ process shown with respect to FIG. 6. This process generates a report for the organization as a whole. It shows a benchmark against the world population, and shows all the users that have a high overall risk. A more complex embodiment would include benchmarking of other risk factors and associated exposure parameters, reports of top risks, top recommendations, and so forth.

Aspects of the present invention have been described by way of example only and it should be appreciated that modifications and additions may be made thereto without departing from the scope thereof as defined in the appended claims.

What is claimed:

1. Computer-executable instructions stored on a computer-readable medium, said computer-executable instructions being adapted to execute the steps of:
(i) extracting at least one user risk variable from a user assessment data set, and
(ii) calculating an exposure parameter based on at least one user risk variable and at least one correlating population risk variable.

2. Computer-executable instructions as claimed in claim 1 wherein the injury for which risk is to be assessed is a repetitive strain injury occurring through the use of a computer.

3. Computer-executable instructions as claimed in claim 1 wherein an exposure parameter is used to identify members of a population of users at high risk of developing an injury.

4. Computer-executable instructions as claimed in claim 1 wherein an exposure parameter is calculated by direct comparison between a user risk variable and its correlating population risk variable.

5. Computer-executable instructions as claimed in claim 1 wherein an exposure parameter is representative of a user's exposure to at least one risk factor.

6. Computer-executable instructions as claimed in claim 5 wherein an exposure parameter is calculated using a risk factor associated with levels of computer use.

7. Computer-executable instructions as claimed in claim 5 wherein an exposure parameter is calculated using a risk factor associated with intensity of computer use.

8. Computer-executable instructions as claimed in claim 5 wherein an exposure parameter is calculated using a risk factor associated with pre-existing injury symptoms.

9. Computer-executable instructions as claimed in claim 5 wherein an exposure parameter is calculated using a risk factor associated with usage ergonomics.

10. Computer-executable instructions as claimed in claim 5 wherein an exposure parameter is calculated using a risk factor associated with a working environment.

11. Computer-executable instructions as claimed in claim 5 wherein an exposure parameter is calculated using a risk factor associated with user characteristics.

12. Computer-executable instructions as claimed in claim 1 wherein the user assessment data includes computer usage information captured during the user's operation of a computer system.

13. Computer-executable instructions as claimed in claim 1 wherein the user assessment data includes user responses to a plurality of questions.

14. Computer-executable instructions as claimed in claim 1 wherein a correlating population risk variable is provided by a plurality of user assessment data sets.

15. Computer-executable instructions as claimed in claim 14 wherein the plurality of user assessment data sets are provided by the peers of the user who is to have their injury risk assessed.

16. Computer-executable instructions as claimed in claim 1 wherein a population risk variable provides the same type of data as its correlating user risk variable.

17. Computer-executable instructions as claimed in claim 14 wherein a population risk variable is calculated from an average of a plurality of correlating risk variables sourced from the population selected for the user.

18. Computer-executable instructions as claimed in claim 14 wherein a population risk variable is selected from the user assessment data of at least one population member at a particular distribution point of the population.

19. Computer-executable instructions as claimed in claim 1 wherein correlating population risk variables are drawn from a dynamic data store which stores a plurality of sets of user assessment data sourced from a plurality of users.

20. Computer-executable instructions as claimed in claim 19 wherein said dynamic data store is configured to dynamically update said stored individual user assessment data sets.

21. An injury risk assessment system adapted to determine at least one user's exposure to at least one risk factor, said system including:
an input means adapted to receive at least one set of user assessment data and at least one population risk variable, and
a processor programmed to extract at least one user risk variable from a received set of user assessment data and to calculate at least one exposure parameter based on a correlated user risk variable and population risk variable.

22. A method of assessing injury risk by determining at least one user's exposure to at least one risk factor, characterised by the steps of:
(i) receiving user assessment data which includes at least one user risk variable, said at least one user risk variable being associated with a risk factor for which at least one user's exposure is to be determined, and
(ii) calculating an exposure parameter for said at least one user based on said at least one user risk variable and at least one correlating population risk variable.
